(19) United States
(12) Patent Application Publication
(10) Pub. No.: US 2005/0252622 A1
(43) Pub. Date: Nov. 17, 2005

(54) Automatic pet door

(75) Inventor: Alister Peter Reid, Preston, Lancashire (GB)

Correspondence Address: CARSTENS YEE & CAHOON, LLP, P O BOX 802334, DALLAS, TX, 75380, US

(73) Assignee: Reilor Holdings Limited, Preston, Lancashire (GB)

(21) Appl. No.: 10/526,909

(22) PCT Filed: Sep. 15, 2003
(86) PCT No.: PCT/GB03/03959

§ 371 Date: Mar. 7, 2005

(30) Foreign Application Priority Data
Sep. 19, 2002 (GB) 0221771.9

(51) Int. Cl. E06B 7/28

(52) U.S. Cl. 160/180

(57) ABSTRACT

A pet door comprising a flap defining a pet access opening, a door flap pivotally mounted in the opening about a pivot axis located at an upper edge of the door flap, a latch mechanism to bar the door flap from opening in at least one direction, and a control mechanism for disabling the latch mechanism to permit the door flap to open in the said at least one direction, the control mechanism including an infrared radiation detector which is mounted above a lower edge of the pet access opening and defines a downwardly directed receiving zone for infrared radiation.

### FIELD OF THE INVENTION

The present invention relates to an automatic pet door and to a key for an automatic pet door.

### BACKGROUND OF THE INVENTION

A number of automatic pet door constructions are known in the art. These known pet door constructions use a variety of different pet detecting systems for unlocking a pet door or for opening a pet door to permit the pet to pass through the door. Some known pet doors are operated by use of an individual key, which is carried by the pet, generally on a collar around the pet's neck, which is encoded. This permits only pets carrying the correctly coded key to be able to pass through the pet door.

Pet doors can generally be divided into doors for use by cats, typically referred to as cat flaps, and doors for use by dogs. For cat flaps, the movable door panel is dimensioned so as to permit nothing larger than a cat to pass therethrough, and generally the door is locked only to prevent unwanted entry by other cats or suitably sized animals into the house from outside. Free access is provided in the opposite direction to permit the cat to leave the house. In contrast, dog doors generally have much larger dimensions than cat doors, and typically are sufficiently large to permit children or even adults to pass therethrough. Consequently, for dog doors, these are generally provided with an additional security feature which locks the door against movement in both directions, so as to prevent young children from being able to leave a house by climbing out through the dog door, or burglars from entering the property from outside.

### SUMMARY OF THE INVENTION

GB-A-2119431 in the name of Reilor Limited discloses a pet door, particularly a cat door, which incorporates a control circuit for a latch on the cat door that responds to the presence of a cat wearing a particular encoded key to open the door and does not respond to the presence of other keys. The control circuit energizes a transmitter/detector coil which is located around the periphery of a door aperture and the coil produces a magnetic field. A cat permitted access through the door wears a key around its neck which comprises a tuned circuit operating at a particular frequency. When a cat wearing a correct key around its neck seeks entry through the cat flap, the magnetic field produced by the coil interacts with the tuned circuit in the key causing a current in the tuned circuit which in turn produces a magnetic field which is picked up by the coil. If the tuned circuit operates with the correct frequency, present in the control circuit, or previously learnt by the control circuit on first use, then this triggers opening of the latch of the cat flap, whereas any other cat seeking entry produces no effect and the latch remains locked.

Although this known automatic cat door provided a coded system by the use of the cat requiring a key for entry, thereby preventing access also to every other cat in the neighbourhood, this known system also suffered from some disadvantages.

It is important for an automatic pet door that the detector system has an accurately controlled operating range, which detects the presence of a pet near to the door and permits the door to be unlatched so that it can be pushed open by the pet before the door has relatched to prevent other animals from passing through the unlatched door. In particular, the use of a tunable key suffered from a poor or variable range, which meant that, if the range was too short, sometimes it was difficult for the cat to be able to pass through the cat flap either because the flap had not unlatched by the time the cat pushed on the door to open it, or, if the range was too long, the flap had re-latched by the time the cat pushed on the door.

Furthermore, because the door was provided with a coil which operated both as a transmitter and a detector, this sometimes led to reliability problems with regard to the control circuit being subject to interference and being unable reliably to pick up the signals from the correct key.

EP-A-0736654 also in the name of Reilor Limited, discloses an automatic pet door in which the latch arrangement uses a magnetic means to permit releasing of the pet door latch. The pet door incorporates a rotatable elongate magnet which is responsive to a magnetic key worn by the pet. Although this simple mechanical magnetic system has a satisfactory range, typically around 15 cm, of operation, and has good reliability, the magnetic keys are not coded. Accordingly, while it is possible to keep out stray animals not wearing any magnetic keys, it is not possible to keep out neighbourhood pets which are wearing the same or similar keys because neighbourhood pet owners have similar pet doors installed.

Electronic dog doors are also known which utilise wireless radio signals emitted from a collar key carried by the dog which are received by a receiver in the pet door. Such an electronic dog door is exemplified by the Model 51 Electronic Dog Door available in commerce under the registered trade mark “STAYWELL” from Reilor Limited, Preston, England. However, such wireless dog doors are expensive to produce because of the requirement for wireless transmitter/receiver units and furthermore it is necessary to license the transmitter and receiver apparatus, which operates in a particular frequency range, with the particular radio frequency licensing authorities in each country in which the electronic dog door is to be used.

U.S. Pat. No. 5,177,900 discloses an automatic pet door incorporating a detector, for receiving a signal from a transmitter unit mounted on a collar of a pet. The detector has a frustoconically shaped receptor shell, and an active receiver region of the detector radiates within a detector angle symmetrically above and below a lone cone-shaped median surface that is normal to the shell and extends outwardly and upwardly from the detector about a vertical detector axis. The cone-shaped medium surface is inclined upwardly from horizontal at a detector elevation angle of about 45°, with the detector angle being approximately 60°. Thus the receiver region extends from a deflector threshold angle of about 15° above horizontal to about 75° above horizontal. The detector is activated when the transmitter unit is elevated by a transmitter angle above the horizontal, within the receiver region, the receiver region extending by a range distance from the detector, symmetrically on opposite sides of a conventional frame wall of the dwelling in which the pet door is mounted.

The door panel is adapted to slide vertically within a pair of grooves in a guillotine-like manner. When the detector detects a signal from the transmitter unit, the door is moved upwardly by a motor unit located above the door panel and an associated arm assembly connected to the top of the door panel. In the illustrated embodiment the transmitter signal is concentrated within a band width having an ultrasonic frequency range. However, it is disclosed that the radiation transmitter for wearing by the pet about its neck to produce a predetermined transmitter signal may be able to produce infrared, ultra-violet, ultra-sound, or electromagnetic radiation.

The pet door disclosed in U.S. Pat. No. 5,177,900 suffers from the problem that the apparatus is quite complicated to manufacture both mechanically and electrically. Electrical components provided for driving the motor and operating the detector are required to be disposed at different locations in the pet door, thereby increasing manufacturing cost and complexity. Moreover, for a dog door requiring latching so as to prevent both unauthorised ingress and ingress with respect to the building, this requires two of the detectors to be provided, one on each side of the pet door. Again, this increases manufacturing cost and complexity. Furthermore, since the detector is required to define a receiver region extending a selected angular width above the horizontal in order for the detector to be able reliably to receive the required transmission signal from the transmitter of the pet collar, this means that the selector is liable to be covered by dirt, scratched, or even damaged as a result of frequent animal passages through the pet door.

U.S. Pat. No. 5,813,364 discloses an automatic pet door housing in which, on each of two opposed sides of the housing, two sensors are positioned on arms which extend perpendicular to the housing. An infrared beam extends between the two sensors. When the beam is interrupted, a signal is sent to a motor located on top of the pet door, which operates a rack and pinion device which works in conjunction with the motor. When a pet walks in between the two arms and the beam is broken, the motor causes the rack and pinion device to engage with teeth found on the top portion of a pet door, thus causing the door to open. Once the pet walks into the open door and the beam is once again continuous, the door closes. Again, this known automatic pet door is relatively complicated to manufacture and produce.

U.S. Pat. No. 5,992,096 discloses a controllable pet access system. The system includes a pet door pivotably connected to the building door, which has an opening therethrough. A motion detector is connectable to one of the doors, either the pet door or the building door, or to an adjacent building structure, and is adapted to direct movement adjacent the pet door. Accordingly, the motion detector is completely separate from the pet door. Solenoids, associated with locking bars, are provided for locking or unlocking the pet door. A reader is connectable to the solenoids and to the motion detector. The reader is actuated in response to a signal from the motion detector which is emitted in response to movement detected by the motion detector. The reader is adapted to deliver a scanning signal to, and to receive a return signal from, an encoded pet tag which is worn on a collar of the pet. In response to receiving a correct and pre-selected return signal from the pet tag, the reader delivers a signal to the solenoids to actuate them, thereby to permit the pet door to be opened. The disclosed controllable pet access system is complicated and cumbersome, requiring not only a motion detector but also a reader for interrogating a pet tag electromagnetically by radio frequency signals. The motion detector and the reader are entirely separate from the pet door, leading to a cumbersome structure with a correspondingly complicated installation procedure.

GB-A-2223257 discloses an electro-magnetically controlled cat door for selective admission of cats carrying a small magnet on their collar. A solenoid in the door is adapted to operate a locking catch and the solenoid is energised in response to sensing of the cat's magnet by a reed switch arrangement.

The present invention at least partially aims to overcome the problems of the known automatic pet doors described hereinabove.

Accordingly, the present invention provides a pet door comprising a flap defining a pet access opening, a door flap pivotally mounted in the opening about a pivot axis located at an upper edge of the door flap, a latch mechanism to bar the door flap from opening in at least one direction, and a control mechanism for disabling the latch mechanism to permit the door flap to open in the said at least one direction, the control mechanism including an infrared radiation detector which is mounted above a lower edge of the pet access opening and defines a downwardly directed receiving zone for infrared radiation.

Preferably, the infrared radiation detector is disposed above the door flap.

Preferably, the infrared radiation detector depends downwardly into an upper edge of the pet access opening.

Preferably, the infrared radiation detector is disposed adjacent to or extends through a hole in a wall defining an upper edge of the pet access opening.

Preferably, the infrared radiation detector is disposed adjacent to an upper portion of the door flap.

Preferably, the downwardly directed receiving zone for infrared radiation is conical.

Preferably, the downwardly directed receiving zone for infrared radiation has a total beam angle of from 60° to 120°, more preferably about 90°.

Preferably, electrical components of the control system are located in a common part of the frame above the pet access opening.

Preferably, the electrical components of the control system and the infrared radiation detector are mounted to a common circuit board located in a cavity of the frame above the pet access opening.

Preferably, the electrical components of the control system include an actuating motor for operating a mechanical actuator for the latch mechanism.

Preferably, the pet door further comprises an attenuating device for ambient infrared radiation in the vicinity of the infrared radiation detector. The attenuating device may comprise an infrared absorbing material or a light filter which is adapted to permit transmission therethrough only of infrared radiation of a selected wavelength.

In one embodiment, the pet door comprises a cat flap, the latch mechanism being arranged to bar the door flap from opening in one direction and the infrared radiation detector being located on the unlatched side of the door flap.

In another embodiment, the pet door comprises a dog door, the latch mechanism being adapted to bar to the door flap from opening in both directions, the infrared radiation detector being located on one side of the door flap, and the door flap is adapted to permit infrared radiation to pass therethrough from the other side of the door flap to be received by the infrared radiation detector.

The latch mechanism may be operated by at least one mechanical actuator operated by at least one actuating motor.

Preferably, the door flap is provided with a window, which is substantially transparent to infrared radiation, adjacent to the infrared radiation detector.

The present invention further provides a key for a pet door, the key comprising a housing which is adapted to be fitted to a pet collar, the housing having a window which is substantially transparent to infrared radiation and containing an infrared radiation transmitter, a control circuit and a source of electrical power, with the infrared radiation transmitter being located adjacent to the window.

Preferably, the housing is adapted to depend downwardly from a pet collar so that the window is in a downwardly directed orientation.

Preferably, the infrared radiation transmitter is adapted to transmit infrared radiation over a downwardly directed conical transmitting zone.

Preferably, for a cat collar key the infrared radiation transmitter has a beam angle with a total angular extent of from 30° to 90°, more preferably in one embodiment of a cat collar key about 60°.

Preferably, for a dog collar key the infrared the infrared radiation transmitter has a beam angle with a total angular extent of from 10° to 40°, more preferably in one embodiment of a dog collar key about 24°.

Preferably. the housing includes a handle and is adapted to be suspended, by the handle, at a selected angular orientation. More preferably, an opening is defined in the handle to receive a suspension element therethrough, and the handle is shaped and positioned so that when the key hangs from the suspension element, the housing is suspended within a particular range of angular inclinations with respect to the horizontal.

Preferably, a beam axis of the infrared transmitter is inclined at an angle of from 20 to 60° to the horizontal when the key is suspended by the suspension element.

Preferably, for a cat collar key a beam axis of the infrared transmitter is inclined at an angle of about 30° to the horizontal when the key is suspended by the suspension element. The handle may be adapted to fix a rigid suspension element at a selected angle with respect to the housing when the key is suspended by the suspension element.

Preferably, for a dog collar key a beam axis of the infrared transmitter is inclined at an angle of about 45° to the horizontal when the key is suspended by the suspension element. The opening of the handle may be positioned relative to the centre of gravity of the key so that when the key is suspended by a suspension element, the key hangs under its own weight with a beam axis of the infrared transmitter at a selected angle with respect to the horizontal.

Preferably, the control circuit is adapted periodically to cause transmission of a coded infrared signal from the infrared radiation transmitter.

The present invention also provides the combination of a pet door according to the invention and a key according to the invention.

The present invention is at least partially predicated on the surprising discovery by the applicant that the transmitter of infrared radiation when mounted on a collar around the neck of a pet such as a cat or a dog, therefore to lie against the throat of the animal in the normal way, does not need to operate in a “direct line of sight” mode. Irrespective of the precise orientation of the infrared transmitter around the animal's neck, infrared radiation tends to be reflected off the fur or coat of the animal in a diffuse manner, and the degree of reflection is sufficiently high so as generally to cause infrared radiation to be directed forwardly of the animal. This reflection can in turn be reflected off the ground and then upwardly towards the receiver which has a downwardly directed receiving zone. Sufficient infrared radiation is transmitted or reflected forwardly from the animal towards the pet door substantially independently of the orientation of the animal's head. Therefore the applicant has discovered that as a result of this phenomenon the infrared transmitter and receiver do not need to operate in a direct line of sight mode but may rather operate in a reflective mode, using the animal itself to cause some reflection of the radiation, with some radiation additionally been reflected off the ground toward the detector. By operating in a reflective mode the infrared radiation detector can be located above a lower edge of the pet door, particularly above the door flap, more particularly above the axis of a hinged pet door having a horizontally oriented hinge along an upper edge of a door flap. This provides three advantages.

A first advantage is that with such a location of the infrared detector, the infrared detector can be provided integral with the circuitry for operating the latching mechanism of the pet door. The latching mechanism is typically located in an upper portion of the pet door to enable the lower portion to be provided with the door flap and the associated opening. The infrared radiation detector can even be mounted directly on a circuit board for the control circuitry. This reduces the complexity of the cat flap, thereby reducing manufacturing costs both with regard to component costs, and manufacturing complexities and assembly time.

A second advantage is that since the infrared radiation detector is always located above the pathway of the animal through the pet door, there is a significantly reduced chance of the detector becoming inadvertently covered with soil or dirt or scratched or otherwise damaged as a result of passage of the animal through the pet door.

A further advantage is that for a dog door, where, as described hereinabove, it is necessary to detect approach of a dog from each of two sides of the dog door so that it is latched against inadvertent opening in both directions, by the provision of an infrared radiation detector above the door flap, this can enable a single detector to be provided which has a detection zone encompassing both sides of the pet door and so is responsive to infrared radiation from either side of the pet door. Also, the single detector can operate a common latch, preventing the door from opening in both directions, by means of a single drive system. This is in contrast to some known dog doors which use two detectors and two latch mechanisms, and drive systems therefor, one for each direction of latching, although these other arrangements are utilisable in accordance with the invention. This enables a significant cost saving as compared to know dog doors having two separate detector systems, each on a respective side of the door, for example as disclosed in U.S. Pat. No. 5,813,364. When the pet door is battery operated, this also increases the battery life.

The present invention is also predicated at least partly on the discovery that for reliable operation of the infrared pet door, in particular controlling an accurate detection range for the device for different size animals and under varying ambient light conditions, while minimising battery power consumption, particularly in the collar key worn by the pet which incorporates an infrared transmitter, beam angles of the infrared transmitter and receiver should ideally be preselected, and also the angle of the beam emitted from the transmitter worn by the pet should ideally be preselected.

### BRIEF DESCRIPTION OF THE DRAWINGS

Embodiments of the present invention will now be described, by way of example only, with reference to the accompanying drawings, in which:

FIG. 1 is an elevational view of a pet door in the form of a cat flap in accordance with an embodiment of the present invention;

FIG. 2 is a longitudinal cross-section through the pet door of FIG. 1, shown fitted to a door of a building together with a cat carrying a collar key;

FIG. 3 shows how the infrared radiation from the collar key worn by the cat of FIG. 2 is detected by the infrared detector of the pet door of FIG. 2;

FIG. 4 is a longitudinal cross-section through a pet door in the form of a dot door in accordance with a second embodiment of the present invention, shown fitted to a door of a building;

FIG. 5 is an elevational view of the door flap of FIG. 4;

FIG. 6 is a side view of a cat collar key in accordance with a further embodiment of the present invention;

FIG. 7 is a top view of the cat collar key of FIG. 6;

FIG. 8 is a side view of the cat collar key of FIG. 6 when carried by a ring and worn on a cat collar;

FIG. 9 is a side view of a dog collar key in accordance with a yet further embodiment of the present invention; and

FIG. 10 is a side view of the dog collar key of FIG. 9 when carried by a ring and worn on a dog collar.

### DETAILED DESCRIPTION OF THE INVENTION

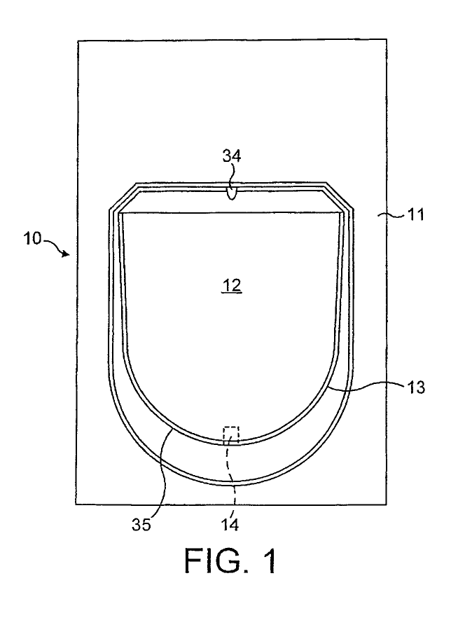

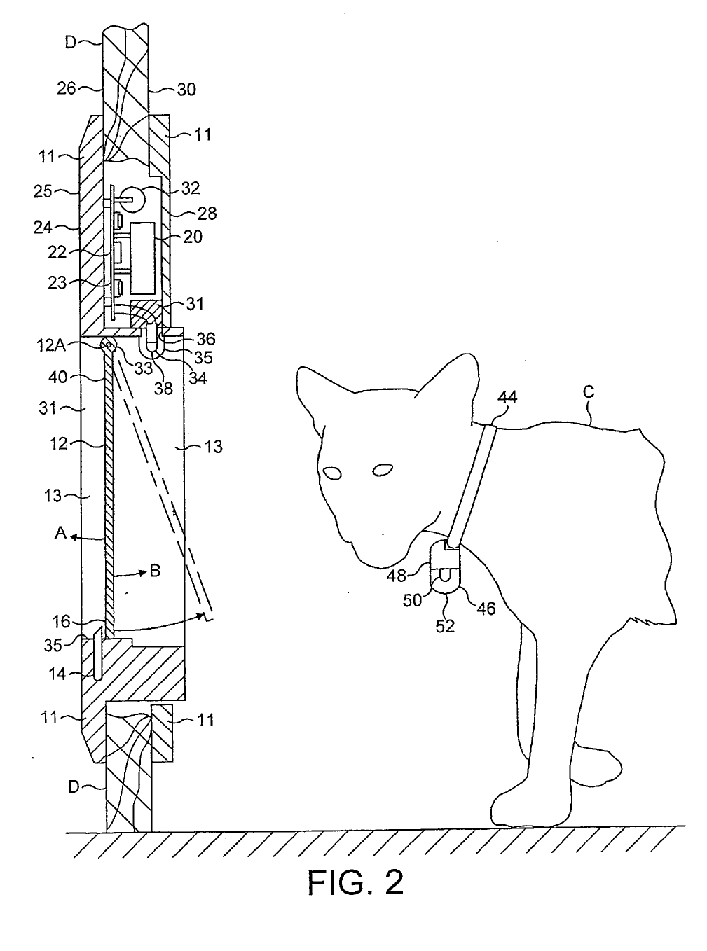

Referring to FIGS. 1 and 2, a pet door 10 in the form of a cat flap comprises a doorframe 11 and a top-hung door flap 12 capable of swinging within a door opening 13. The door flap 12 can be swung in either direction about its top hinge axis 12A to allow a pet to pass through the door opening 13. The axis 12A is horizontally oriented. In this embodiment, the pet door is a cat flap and accordingly a latch mechanism 14 is provided which engages with a lower edge 16 of the flap 12 and normally prevents or disables movement of the flap 12 in one direction, indicated by arrow A in FIG. 2. When installed, for example in a door D of a building, direction A will usually be in the inward opening direction, i.e. from outside the building into the building. Although inward opening is normally barred by the latch mechanism 14, the latch mechanism 14 does not hinder the opening of the flap 12 in the opposite direction, marked by arrow B in FIG. 2, so that pets may have a ready egress from the building.

This embodiment uses a particular latch mechanism, although other latch mechanisms may readily be employed in accordance with the invention.

As shown in FIG. 2, in the locked configuration the latch mechanism 14 is in an upward position thereby to bear against the lower edge 16 of the flap 12. In the unlocked configuration, the latch mechanism 14 is lowered so as to be retracted within the frame 11, thereby to be a downward position beneath the arc of movement of the lower edge 16 of the flap 12, thereby by permitting a pet to push the door flap 12 in the direction of arrow A and enter the building.

The latch mechanism 14 is normally biased upwardly into the locked configuration and is caused to be retracted into the downward unlatched position by operation of an actuating motor 20. The actuating motor 20 is disposed, together with a control circuit 22 on a circuit board 23, in an upper portion 24 of the pet door 10 and in particular in and on an inner frame part 25 of the pet door 10, which is affixed to an inner side 26 of the door D. Alternatively, the actuating motor 20 is remote from the circuit board 23 and in the vicinity of the latch mechanism 14. An outer frame part 28 of the pet door 10 mates with the inner frame part 25 and is affixed to an outer surface 30 of the door D. In this embodiment, the pet door is battery operated and electrical batteries 32 are connected to the control circuit 22.

In this way, the entire electronic circuitry and electrical components, including the actuating motor 20, are formed as a single unit which is mounted at a single location above an upper edge 33 of the flap 12 in the upper portion 24 of the pet door 10 and furthermore is mounted to a single part, the inner frame part 25, of the two-part pet door 10 for sandwiching around a door D.

The actuating motor 20 is connected via actuating arms (not shown) to the latch mechanism 14. The construction and operation of such actuating arms is known to a person skilled in the art, for example from the Model 500, Model 520 and Model 540 Battery Powered Cat Flaps available in commerce under the Registered Trade Mark “STAYWELL” from Reilor Limited, Preston, England. When the actuating motor 20 is actuated, the actuating arms retract the latch mechanism 14 against the bias of a biasing element (not shown) for a selected period of time, which may be adjustable. After the selected period of time, the latch mechanism 14 is released and is urged upwardly by the bias into the upward locked position.

In a particular embodiment, when the door flap 12 is to be opened, the actuating motor 20 turns about ¾ of a revolution. The end of the actuating motor 20 is attached to a lever and cam arrangement (not shown) of the mechanical actuator which allows the latch mechanism 14 to be pushed down. When the lock signal is received from the control circuit (after the selected period of time), the actuating motor 20 is rotated back to the start position, resulting in the latch mechanism 14 being fixed in the locked position.

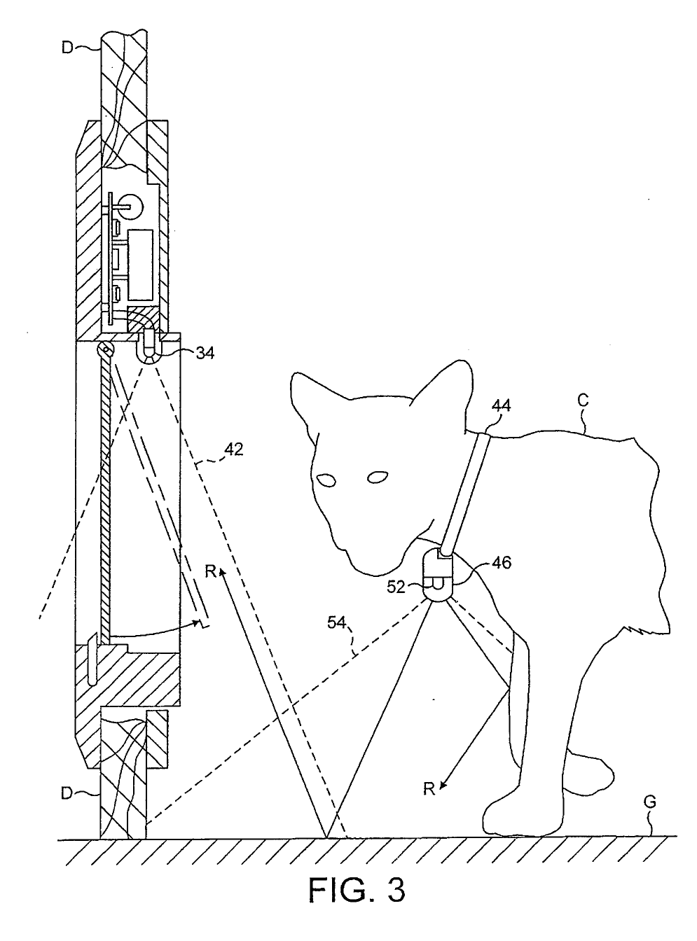

In accordance with the present invention, an infrared detector 34 is disposed above a lower edge 35 of the door opening 13, the lower edge 35 being part of the frame 11, and in particular above the door flap 12 in the door opening 13, to enable the pet to pass thereunder. The infrared detector 34 is mounted directly on the circuit board 23. The infrared detector 34 depends downwardly into the upper part of the opening 13 so as to extend through a hole 36 formed in the inner frame part 25 of the pet door 10 so that a lower end 38 of the infrared detector 34 is exposed adjacent an upper portion 40 of the door flap 12. The infrared detector 34 may be adjacent to the hole 36, rather than extend through it. The infrared detector 34 is of a known type which is adapted to define a conical infrared receiving zone 42, shown in phantom in FIG. 3, known in the art as a half power beamwidth. The zone 42 has a beam angle encompassing a sensitivity of 50% of its peak (axial or boresight) sensitivity. The zone 42 is downwardly directed. Typically, the total beam angle of the zone is about 90° (i.e. 45° on each side of a central beam axis), although it may range from 60° to 120°. A wider beam angle tends to provide a broader area for reliable reception of an infrared signal from a pet, for example to accommodate different pet sizes (particularly for dogs), movement of the pet, and other variables.

The infrared detector 34 may be centrally located across the width of the door opening 13 (as shown in the drawings) or it may be laterally offset to one side so as to be off-centre (not shown), the latter case providing the advantage that this may decrease the attenuation, by the head of the cat, of the incoming infrared radiation to be detected. When so laterally offset, the infrared detector 34 may be located on a side edge 37 of the frame 11 defining the door opening 13, preferably an upper portion of the side edge 37. Optionally, the inner surfaces of the frame of the pet door 10 surrounding the opening may act as reflective surfaces for enhancing the reflected infrared radiation received by the detector 34. If desired, a short tunnel-like configuration may be integrally provided or attached to the pet door 10 to enlarge the reflective surface area.

Sunlight includes infrared radiation and in ambient weather conditions of strong sunlight, the increased amount of ambient infrared radiation may affect the performance of the pet door, since the detector may less reliably detect an infrared signal from a collar key worn by a pet. In order to make the infrared detector 34 less liable to performance variability due to changes in ambient light, an attenuating device for ambient infrared radiation may be provided in the vicinity of the infrared detector 34. In particular, the rear and/or sides of the infrared detector 34 may be masked by an infrared absorbing material 31, such as a black plastics foam. This prevents or at least restricts ambient light from incidence on the back of the detector 34 which would otherwise upset its performance. Additionally or alternatively the infrared detector 34 may be located behind a light filter 35, which is adapted to permit transmission therethrough only of radiation of a selected wavelength, typically about 940 nm, the wavelength of infrared radiation emitted by the collar key worn by a pet. In this way, the infrared absorbing material and/or the filter can restrict ambient infrared radiation from being incident on the detector 34, thereby improving device reliability, particularly in strong sunlight.

As also shown in FIG. 2, a cat C permitted to use the pet door 10 is provided with a collar 44 around its neck on which is mounted a collar key 46. The collar key 46 comprises a tubular housing 48 containing an infrared radiation transmitter 50 which is controlled by a control circuit and powered by electrical batteries (both not shown), all of which are contained within the housing 48. An end of the housing 48 is provided with a window 52 which is substantially transparent to infrared radiation and through which the infrared radiation is passed from the transmitter 50. The window 52 may comprise a lens.

Typically, the infrared transmitter 50, which itself is of known construction, transmits infrared radiation over a conical transmitting zone 54, as shown in phantom in FIG. 3, constituted by the half-power beamwidth. Again, it has been found that higher beam angles tend to increase the power consumption of the battery in the collar key 46 for a given range of the transmitter 50.

The infrared transmitter 50 is adapted, in known manner, periodically to transmit a modulated and encoded signal, for example signals similar to those used for infrared remote controllers and infrared remote control locking mechanisms, which may be received by the infrared detector 34. When the infrared detector 34 detects incoming infrared radiation, the signal is decoded by the control circuitry 22 to determine whether or not the signal matches that preset or previously leamt by the control circuitry 22, and if the signal is the correct signal, the actuator motor 20 is operated to unlatch the latching mechanism 14.

Referring to FIG. 3, this shows the inter-reaction between the cat's body, the ground, the infrared radiation from the transmitter 52 and the detecting zone of the infrared receiver 34. It may be seen that as a cat C wearing a collar key 46 approaches the pet door 10, the infrared radiation R transmitted from the collar key 46 is not only directly transmitted forwardly within the conical transmitting zone 54, which is determined by the location and orientation of the collar key 46 on the collar 44 around the neck of the cat C, but also infrared radiation is forwardly reflected off the coat of the cat C. This causes a large body of diffuse infrared radiation R to be transmitted and reflected forwardly of the cat C. In addition, the infrared radiation tends to reflect off the ground G directly from the cat C. A large proportion of this radiation entering the infrared receiving zone 42 can be picked up by the infrared detector 34, even though in some circumstances there is no direct line of sight between the infrared transmitter 52 in the collar key and the infrared detector 34. As a result of the collar key 46 being operable to cause infrared radiation to be reflected off the coat of the cat C, and off the ground, which can thereafter be detected by the infrared detector 34, the range of detection can be reliably controlled to about 15 cm ±5 cm. This ensures reliable operation of the pet door 10, in conjunction with a coded collar key 46. The range is preset during manufacture by adjusting a resistance in the control circuit of the collar key 46, which adjusts the intensity of the infrared radiation transmitted by the transmitter 52.

It is believed that this accuracy in the establishing of a detection range for the pet, about 15 cm for a cat, results from the use of reflected infrared radiation, rather than direct radiation which would be used in a “line of sight” arrangement. This provides the advantage of greater accuracy and controllability in establishing an operating range as compared to some known devices. In turn, this makes it easier for the pet reliably to be able to unlock the pet door and pass therethrough.

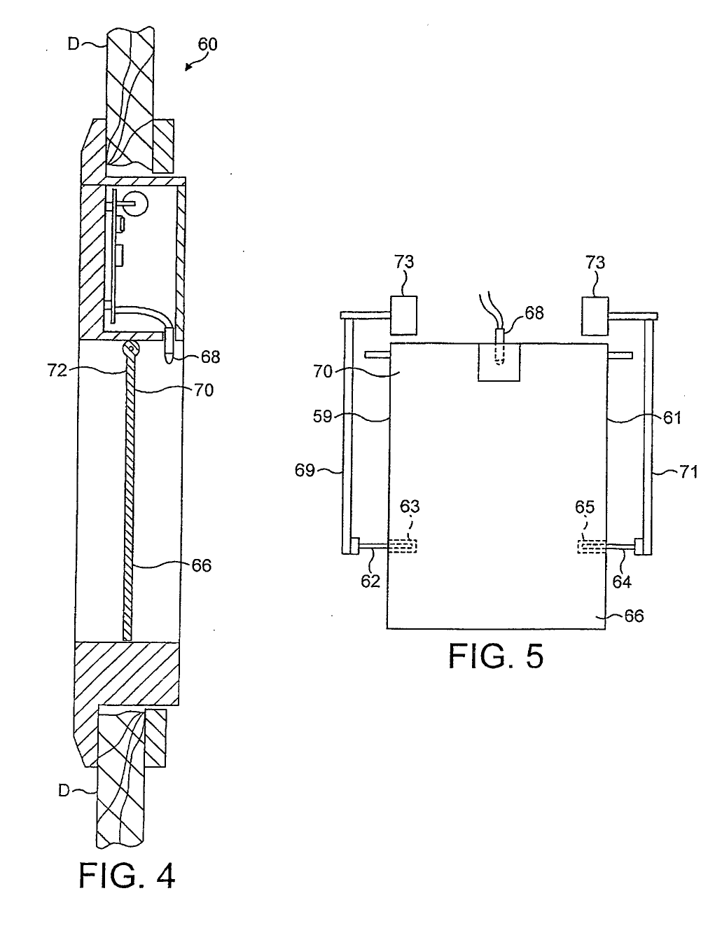

Referring to FIG. 4, there is shown a dog door in accordance with a second embodiment of the present invention. The dog door 60 differs from the cat flap of the first embodiment in that the door flap is latched against opening in both directions. Thus a pair of latch mechanisms 62,64 are provided on opposed vertical edges 59,61 of the door flap 66, which mechanisms 62,64 extend when latched into respective recesses 63,65 in the respective edge 59,61 of the flap 66. The latching mechanisms 62,64 are in this embodiment opened by respective actuator mechanisms 69,71 (schematically represented in FIG. 5) controlled by respective actuating motors 73,75 (schematically represented in FIG. 5) which operate in the same manner as for the cat flap of the first embodiment. Alternatively, the actuating motors 73,75 are remote from the circuit board and in the vicinity of the respective latch mechanisms 62,64. Alternatively, a common latching mechanism, which prevents movement of the door in both angular directions, may be operated by a single actuator mechanism driven by a single actuating motor.

Again, other types of latching mechanisms may be used for the dog door.

In this embodiment, a single infrared detector 68 is provided as for the cat flap, but, as shown in FIG. 5, in order to be able to detect the presence of a dog inside the building, as well as outside the building, the door flap 66 is provided, at an upper portion 70 thereof, with a window 72 part which is transparent to infrared radiation and aligned with the infrared detector 68. In this way, the infrared detector can detect infrared radiation transmitted from a coded collar key (not shown) on the inside of the dog door, as well as the outside. Again, the infrared detector 68 may be centrally located across the width of the door opening or it may be laterally offset to one side, the latter case providing the advantage that this may decrease the attenuation, by the head of the dog, of the incoming infrared radiation to be detected.

In an alternative construction, the door flap 66 is made throughout of an infrared transparent material, in which case it is not necessary to provide such a window. In yet further alternative embodiments of the door flap 66, two detector systems may be provided, each on a respective side of the flap 66, and a pair of latching mechanisms are provided, each associated with a respective detector. However, with such an embodiment, power consumption is greater than for the single detector embodiment.

In an alternative embodiment of the pet door of the invention, the infrared detector may be located directly above the door flap, in particular above the horizontal hinge axis.

As described above, the pet door of the present invention operates as a result of infrared radiation, which is emitted from the transmitter carried by the pet, to be reflected or bounced off a surface, particularly the ground, prior to being received by the infrared radiation detector mounted above a lower edge of the pet access opening. For the infrared radiation transmitter in the collar key, there is, in practice, a complicated relationship between the beam angle of an infrared emission zone (a beam angle corresponding to a sensitivity 50% of the peak (axial or boresight) sensitivity), battery lifetime and device performance and reliability.

Ideally, the battery in the collar key should be as small and light as possible, particularly when used for a cat, yet it should have as long a battery life as possible, by reducing the power requirements of the infrared transmitter. However, if the power of the infrared transmitter is reduced, then correspondingly, the intensity of the emitted infrared radiation is reduced, which can tend to reduce the reliability of operation of the pet door. The pet door is required to operate for a variety of different ambient light conditions, and for example, in strong sunlight, it is necessary that the intensity of infrared radiation emission from the collar key is sufficient, in particular sufficiently in excess of the ambient infrared radiation from sunlight, to cause the pet door to be opened reliably. The applicant has found that by reducing the beam angle of the infrared transmitter, this can ensure a sufficiently high intensity of infrared radiation across the beam width for any given power drain requirement of the battery.

For a cat collar key, typically the infrared transmitter has a beam angle of ±30° about a central axis, thereby giving a total angular extent of 60° for the infrared beam emitting from the transmitter. At a typically detection range of about 15 cm for a cat, this provides a sufficiently wide infrared beam for reliable detection by the infrared detector. However, the beam angle may range from ±15° about a central axis, thereby giving a total angular extent of 30°, to ±45° about a central axis, thereby giving a total angular extent of 90°.

For a dog collar key, the detection range, which depends upon the size of the dog, can vary significantly but generally is greater than the cat detection range. Furthermore, the height of the collar key on the dog, and consequently the height of the infrared transmitter above the ground, tends to vary from dog to dog. To accommodate these differences, the beam angle of the infrared transmitter for the dog collar key is lower than for a cat, typically being about ±12° about a central beam access giving a total angular extent for the infrared beam of about 24°. However, the beam angle may range from ±5° about a central axis, thereby giving a total angular extent of 10°, to ±20° about a central axis, thereby giving a total angular extent of 40°. Such a lower beam angle tends, for a given power consumption of the infrared transmitter, to provide a higher intensity of infrared radiation, which in turn increases the reliable detection range in varying ambient light conditions and more readily accommodates different dog sizes. Put another way, the reduction in the beam angle enables the detection range to be adequate while minimising power consumption and thereby extending battery life.

In yet further aspects of the invention, the keys are modified so as to provide that the keys, when suspended from a pet collar, are adapted to emit a beam of infrared radiation which is inclined to the horizontal (and vertical), and thereby the beam is more reliably able to be reflected off other surfaces, most particularly the ground, so as to be received by the infrared detector in the pet door. Again, this can enhance device reliability, particularly for different ambient light conditions.

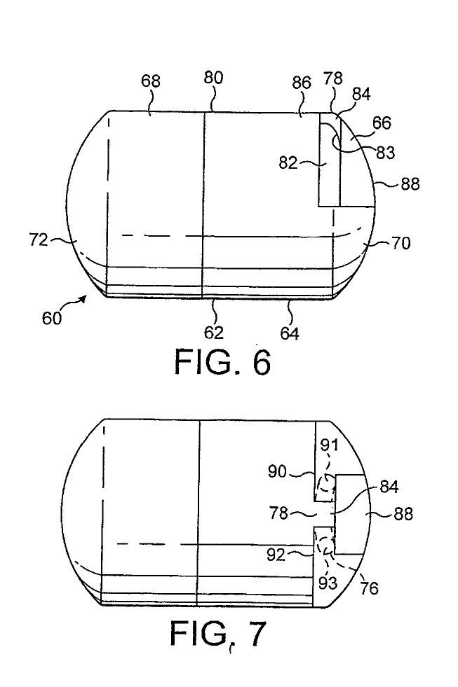

Referring to FIGS. 6 and 7, a cat collar key 60 in accordance with an embodiment of the present invention comprises a housing 62 for the electrical components (not shown), including the infrared transmitter, electrical control circuitry and battery as described above. The housing 62 comprises two parts assembled together, namely a first body part 64, typically opaque, which is provided with a mount 66 for connecting the key 60, typically by a ring 76 (shown by dashed lines in FIG. 7), for example of metal, to a pet collar (not shown), and a second lens part 68, which is transparent at least to infrared radiation from the transmitter located within the housing 62. In the illustrated embodiment, the housing 62 is generally cylindrical and has opposed hemispherical ends 70,72, the hemispherical end 70 of the body part 64 comprising the mount 66 and the hemispherical end 72 of the lens part 68 being adjacent to and covering the infrared transmitter. However, other shapes for the housing may be employed.

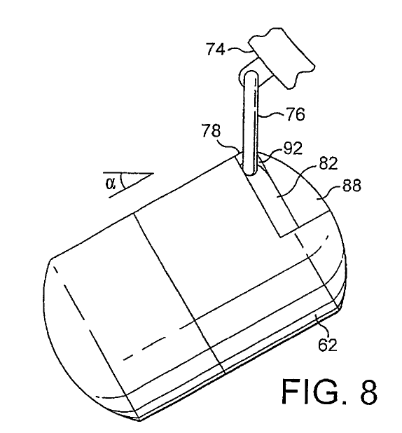

As shown more clearly in FIG. 8, the mount 66 is configured so that the housing 62 may be fitted to a pet collar 94, for example by the metal ring 76 as described above, in a selected orientation, in particular at a selected angular inclination with respect to the horizontal (and thereby to the ground) when worn by the cat. In the illustrated embodiment, the mount 66, which comprises an integrally moulded handle 78, extends from one side, in use the upper side 80, of the housing 62 to the hemispherical end 70 of the body part 64, thereby to define an opening 82 between the handle 78 and the body part 64. The metal ring 76 is securely held in the opening 82. The opening 82 has a substantially rectangular cross-section, when viewed from the side as in FIGS. 6 and 8, although an uppermost edge 83 of the opening 82 is downwardly and outwardly inclined. The opening 82 is oriented so as to be orthogonal to the axis of the housing 62, which in the embodiment is parallel to the beam axis of the infrared transmitter (not shown). The handle 78 is defined by two integral parts, namely a first relatively narrow (in a circumferential direction) upper part 84 extending from the cylindrical portion 86 of the body part 64 and a second relatively broad (in a circumferential direction) lower part 88 extending from the hemispherical end 70. The outer surface of the lower part 88 comprises part of the hemispherical surface of the hemispherical end 70. Such a provision of a relatively narrow upper part 84 and a relatively broad lower part 88 of the handle 78 forms, as shown in FIG. 7, two opposed notches 90,92, each on a respective side of the narrow part 84 of the handle 78.

Accordingly, as shown in FIG. 8, when a metal ring 76 is received in the opening 82, and the cat collar key 60 hangs from the ring 76 under its own weight when the ring 76 is suspended from a cat collar 94, two spaced sections 91, 93 (see FIG. 7) of the ring 76 each become engaged in a respective notch 90,92 defined in the handle 78. This causes the housing 62 to be suspended within a particular range of angular inclinations with respect to the horizontal. This correspondingly causes the beam from the infrared transmitter to be inclined at a particular angle α, or range of angles about that angle, typically from 20 to 60°, to the horizontal when the cat collar key 60 is worn by a cat on the collar 94. In the illustrated embodiment, the beam of infrared radiation from the infrared transmitter is parallel to the axis of the housing 62, although of course this is not essential, and the beam axis may have any orientation and relation to the shape and dimensions of the housing 62. However, for any such shape and dimensions of the housing 62, by controlling the angular orientation of the housing 62 when suspended from the pet collar 94, this correspondingly controls the angle of orientation of the beam, most typically so that the emitted beam of infrared radiation is at an angle α of about 30° to the horizontal.

By controlling the angular orientation of the transmitted infrared beam from the pet collar key, this enhances the reliability of operation of the infrared pet door because this tends to enhance the amount of reflected infrared radiation reaching the detector, in particular under a variety of ambient conditions, including strong sunlight as discussed hereinabove.

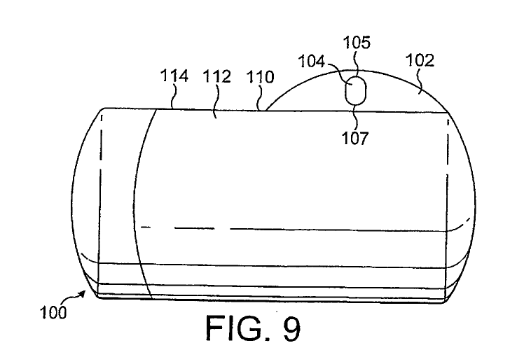

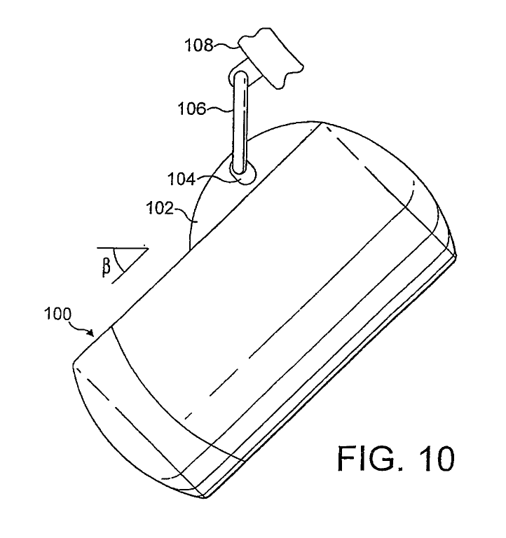

Referring to FIGS. 9 and 10, there is shown a dog collar key 100 in accordance with another embodiment of the present invention. This is a modification of the cat collar key and also includes a housing with two parts, a body part and a lens part, with electrical components including the infrared transmitter located within the housing.

In this embodiment a handle 102, which includes an opening 104 therethrough for receiving a ring 106, for example of metal, for suspending the collar key 100 from a dog collar 108, extends upwardly away from an upper side 110 of the body part 112 of the housing 114. The opening 104, when viewed from the side, has a substantially rectangular elongate cross-section, but with rounded ends 105,107. The opening 104 is oriented so as to be orthogonal to the axis of the housing 114, which in the embodiment is parallel to the beam axis of the infrared transmitter (not shown). As for cat collar key of the previous embodiment, the opening 104 is positioned, shaped and dimensioned so that when the collar key 100 is suspended from the metal ring 106 extending through the opening 104, the beam axis of the transmitter, and correspondingly the axis of the housing 114 when the two axes are parallel, is at a predetermined angle β, in particular about 450, relative to the horizontal or within a predetermined angular range, typically from 20 to 60°, encompassing that angle β. In this embodiment, the location of the upper end 105 of the opening 104 relative to the centre of gravity of the collar key 104 is preselected so as to determine the angle that the collar key 104 hangs from the metal ring 106, rather than the provision of notches in the collar key to fix the orientation of the collar key relative to the metal ring as for the cat collar key embodiment.

The beam axis of the dog collar key tends to be more vertically oriented than the beam axis of the cat collar key because of the likelihood of the dog collar key, when used, being higher off the ground than the cat collar key because dogs tend to be bigger than cats.

1. A pet door comprising a flap defining a pet access opening, a door flap pivotally mounted in the opening about a pivot axis located at an upper edge of the door flap, a latch mechanism to bar the door flap from opening in at least one direction, and a control mechanism for disabling the latch mechanism to permit the door flap to open in the said at least one direction, the control mechanism including an infrared radiation detector which is mounted above a lower edge of the pet access opening and defines a downwardly directed receiving zone for infrared radiation.

2. A pet door according to claim 1 wherein the infrared radiation detector is disposed above the door flap.

3. A pet door according to claim 1 wherein the infrared radiation detector depends downwardly into an upper edge of the pet access opening.

4. A pet door according to claim 1 wherein the infrared radiation detector is disposed adjacent to or extends through a hole in a wall defining an upper edge of the pet access opening.

5. A pet door according to claim 1 wherein the infrared radiation detector is disposed adjacent to an upper portion of the door flap.

6. A pet door according to claim 1 wherein the downwardly directed receiving zone for infrared radiation is conical.

7. A pet door according to claim 1 wherein the downwardly directed receiving zone for infrared radiation has a total beam angle of from 60° to 120°.

8. A pet door according to claim 7 wherein the downwardly directed receiving zone for infrared radiation has a total beam angle of about 90°.

9. A pet door according to claim 1 wherein electrical components of the control system are located in a common part of the frame above the pet access opening.

10. A pet door according to claim 9 wherein the electrical components of the control system and the infrared radiation detector are mounted to a common circuit board located in a cavity of the frame above the pet access opening.

11. A pet door according to claim 9 wherein the electrical components of the control system include an actuator motor for operating a mechanical actuator for the latch mechanism.

12. A pet door according to claim 1 further comprising an attenuating device for ambient infrared radiation in the vicinity of the infrared radiation detector.

13. A pet door according to claim 12 wherein the attenuating device comprises an infrared absorbing material.

14. A pet door according to claim 12 wherein the attenuating device comprises a light filter which is adapted to permit transmission therethrough only of infrared radiation of a selected wavelength.

15. A pet door according to claim 1 which comprises a cat flap, the latch mechanism being arranged to bar the door flap from opening in one direction and the infrared radiation detector being located on the unlatched side of the door flap.

16. A pet door according to claim 1 which comprises a dog door, the latch mechanism being adapted to bar to the door flap from opening in both directions, the infrared radiation detector being located on one side of the door flap, and the door flap is adapted to permit infrared radiation to pass therethrough from the other side of the door flap to be received by the infrared radiation detector.

17. A pet door according to claim 11 which comprises a dog door, the latch mechanism being adapted to bar to the door flap from opening in both directions, the infrared radiation detector being located on one side of the door flap, and the door flap is adapted to permit infrared radiation to pass therethrough from the other side of the door flap to be received by the infrared radiation detector wherein the latch mechanism is operated by at least one mechanical actuator operated by at least one actuating motor.

18. A pet flap according to claim 16 wherein the door flap is provided with a window, which is substantially transparent to infrared radiation, adjacent to the infrared radiation detector.

19. A key for a pet door, the key comprising a housing which is adapted to be fitted to a pet collar, the housing having a window which is substantially transparent to infrared radiation and containing an infrared radiation transmitter, a control circuit and a source of electrical power, with the infrared radiation transmitter being located adjacent to the window.

20. A key according to claim 19 wherein the housing is adapted to depend downwardly from a pet collar so that the window is in a downwardly directed orientation.

21. A key according to claim 20 wherein the infrared radiation transmitter is adapted to transmit infrared radiation over a downwardly directed conical transmitting zone.

22. A key according to claim 19 wherein the infrared radiation transmitter has a beam angle with a total angular extent of from 30° to 90°.

23. A key according to claim 22 wherein the infrared radiation transmitter has a beam angle with a total angular extent of about 60°.

24. A key according to claim 19 wherein the infrared radiation transmitter has a beam angle with a total angular extent of from 10° to 40°.

25. A key according to claim 24 wherein the infrared radiation transmitter has a beam angle with a total angular extent of about 24°.

26. A key according to 19 wherein the housing includes a handle and is adapted to be suspended, by the handle, at a selected angular orientation.

27. A key according to claim 26 wherein an opening is defined in the handle to receive a suspension element therethrough, and the handle is shaped and positioned so that when the key hangs from the suspension element, the housing is suspended within a particular range of angular inclinations with respect to the horizontal.

28. A key according to claim 27 wherein a beam axis of the infrared transmitter is inclined at an angle of from 20 to 60° to the horizontal when the key is suspended by the suspension element.

29. A key according to claim 28 wherein a beam axis of the infrared transmitter is inclined at an angle of about 30° to the horizontal when the key is suspended by the suspension element.

30. A key according to claim 27 wherein the handle is adapted to fix a rigid suspension element at a selected angle with respect to the housing when the key is suspended by the suspension element.

31. A key according to claim 27 wherein a beam axis of the infrared transmitter is inclined at an angle of about 45° to the horizontal when the key is suspended by the suspension element.

32. A key according to claim 27 wherein the opening of the handle is positioned relative to the centre of gravity of the key so that when the key is suspended by a suspension element, the key hangs under its own weight with a beam axis of the infrared transmitter at a selected angle with respect to the horizontal.

33. A key according to claim 19 wherein the control circuit is adapted periodically to cause transmission of a coded infrared signal from the infrared radiation transmitter.

34. The combination of a pet door according to claim 1 and a key according to claim 19.

35. (canceled)

36. (canceled)

37. A pet door comprising a flap defining a pet access opening, a door flap pivotally mounted in the opening about a pivot axis located at an upper edge of the door flap, a latch mechanism to bar the door flap from opening in at least one direction, a control mechanism for disabling the latch mechanism to permit the door flap to open in the said at least one direction, the control mechanism including an infrared radiation detector which is mounted above the door flap and defines a downwardly directed conical receiving zone for infrared radiation which has a total beam angle of from 60° to 120°, and an attenuating device for ambient infrared radiation in the vicinity of the infrared radiation detector.
